(19) United States
(12) Patent Application Publication
(10) Pub. No.: US 2010/0291368 A1
(43) Pub. Date: Nov. 18, 2010

(54) MOISTURE-CURING HOT-MELT ADHESIVE COMPOUND CONTAINING POLYALDIMINE

(75) Inventors: Urs Burckhardt, Zurich (CH); Kai Paschkowski, Jork (DE); Martin Linnenbrink, Apensen (DE); Sven Rosenau, Hamburg (DE)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/312,180

(22) PCT Filed: Nov. 16, 2007
(86) PCT No.: PCT/EP2007/062468

§ 371 Date: Jun. 9, 2009

(30) Foreign Application Priority Data
Nov. 17, 2006 (EP) 06124348.1

(51) Int. Cl. B32B 27/40; C08F 283/04; B32B 17/10

(52) U.S. Cl. 428/221; 525/454; 156/331.1; 428/423.1; 156/99

(57) ABSTRACT

The present invention relates to moisture-reactive hot-melt adhesive compounds, comprising at least one polyurethane polymer P which is solid at room temperature and which has isocyanate groups, at least one polyaldimine ALD of the formula (Ia) or (Ib), and at least one acid K in the form of an organic monocarbon acid, or dicarbon acid, or an organic monosulphonic acid, or disulphonic acid, or a compound which can be hydrolyzed to give one of these acids. These hot-melt adhesive compounds cure without bubbles and exhibit exceptionally quick crosslinking speed and good strength after crosslinking.

### FIELD OF THE INVENTION

The invention relates to the field of moisture-curing hotmelt adhesives.

### DESCRIPTION OF THE PRIOR ART

Hotmelt adhesives (hotmelts) are adhesives which are based on thermoplastic polymers. These polymers, which are solid at room temperature, soften on heating to form viscous liquids and can therefore be applied as a melt. In contrast to the so-called warmmelt adhesives (warmmelts), which have a pastelike consistency and are applied at slightly elevated temperatures, typically in the range from 40 to 80° C., the hotmelt adhesives are applied at temperatures above 80° C., typically above 85° C. On cooling to room temperature, they solidify, and the bond strength is developed at the same time. Conventional hotmelt adhesives are nonreactive adhesives. On heating they soften or melt again, making them unsuitable for use at elevated temperature. Moreover, conventional hotmelt adhesives tend often to exhibit creep (cold flow) even at temperatures well below the softening point.

In the case of the so-called reactive hotmelt adhesives, these disadvantages have been largely eliminated through the introduction into the polymer structure of reactive groups that lead to crosslinking. Particularly suitable reactive hotmelt adhesives are polyurethane compositions, also referred to for short as PUR-RHM. They are typically composed of polyurethane polymers which contain isocyanate groups and which are obtained by reacting suitable polyols with an excess of diisocyanates. Following application they rapidly develop a high bond strength, by cooling, and acquire their ultimate properties, more particularly heat stability and resistance to environmental effects, by the post-crosslinking of the polyurethane polymer as a result of the reaction of the isocyanate groups with moisture. Because of the carbon dioxide gas formed in the crosslinking reaction, however, there is a risk of bubbles forming in the adhesive, which can reduce the ultimate strength and the substrate adhesion and also, in the case of visible bonds, as in the packaging segment, for example, may adversely affect the esthetics. Particularly prone to forming bubbles are amorphous PUR-RHM, since the skin of cured adhesive that forms from the surface is highly impervious to carbon dioxide. At the same time, the skin lets hardly any moisture penetrate the deep-down layers of adhesive that have not yet cured, and so, in adhesives of this kind, particularly when applied at layer thicknesses of 500 micrometers or more, complete crosslinking takes a very great time or does not come about at all.

In the field of one-component polyurethanes which are applied at room temperature, systems which cure without bubbles are known. They typically include latent curing agents, more particularly polyaldimines. WO 2004/013200 A1 describes compositions which can be applied at room temperature, comprise polyaldimines, and cure without a nuisance odor.

### SUMMARY OF THE INVENTION

It is an object of the invention to provide a polyurethane composition which can be used as a reactive hotmelt adhesive, which is stable on storage, and which even on thick-layer application cures without forming bubbles. The objective, moreover, is that crosslinking should take place rapidly and completely and that the adhesive should have a good ultimate strength.

Surprisingly it has been found that this object can be achieved through the moisture-reactive hotmelt adhesive composition of claim 1. It has been found that the rate of crosslinking which takes place substantially in the cooled, i.e., solid, state, is significantly increased as compared with compositions which contain no polyaldimines. This is very surprising because the crosslinking of isocyanate groups by polyaldimines in fact requires more water than the crosslinking of isocyanate groups via water alone. In particular it emerged that the crosslinking rate is increased to a particularly great extent in the case of amorphous hotmelt adhesive compositions. Moreover it became apparent, very surprisingly, that, despite the high temperatures that prevail during their application and despite the polyaldimines that are present in the composition, and/or the aldehydes that are formed from them on hydrolysis, the hotmelt adhesive compositions are to a large extent odorless, or at least of low odor. The crosslinked adhesives have the advantages of absence of bubbles and good ultimate strength.

In further aspects the invention relates to a method of adhesive bonding of claim 17, the resultant articles of claim 22, and a method of reducing bubble formation and of accelerating the chemical crosslinking of amorphous, moisture-reactive hotmelt adhesive compositions of claim 24.

Preferred embodiments are subject matter of the dependent claims.

### DESCRIPTION OF THE PREFERRED EMBODIMENTS

The present invention provides moisture-reactive hotmelt adhesive compositions comprising
a) at least one polyurethane polymer P which is solid at room temperature and contains isocyanate groups,
b) at least one polyaldimine ALD of the formula (I a) or (I b),

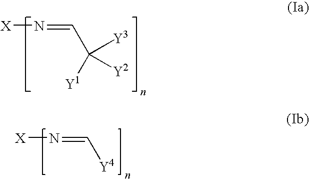

where in formula (I a) or (I b)
X is the organic radical of an n-functional primary polyamine following removal of n aliphatic primary amino groups, this organic radical containing no moieties which in the absence of water are reactive with isocyanate groups, in particular no hydroxyl groups, no secondary amino groups, no urea groups, and no other groups with active hydrogen;
n is 2 or 3 or 4,
Y¹ and Y² either independently of one another
are each a monovalent hydrocarbon radical having 1 to 12 C atoms,
or together are a divalent hydrocarbon radical having 4 to 20 C atoms which is part of an optionally substituted carbocyclic ring having 5 to 8, preferably 6, C atoms;
   Y³ is a monovalent hydrocarbon radical which optionally contains at least one heteroatom, more particularly oxygen in the form of ether, carbonyl or ester groups;
   Y⁴ alternatively
is a substituted or unsubstituted aryl or heteroaryl group which has a ring size of between 5 and 8, preferably 6, atoms
or is

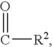

where R² is a hydrogen atom or is an alkoxy group,
or is a substituted or unsubstituted alkenyl or arylalkenyl group having at least 6 C atoms;
c) at least one acid K in the form of an organic monocarboxylic acid or dicarboxylic acid or of an organic monosulfonic acid or disulfonic acid, or of a compound which can be hydrolyzed to one of these acids.

The term “polymer” in the present document embraces on the one hand a collective of chemically uniform macromolecules which nevertheless differ in respect of degree of polymerization, molar mass, and chain length and have been prepared by a polymerization reaction (addition polymerization, polyaddition, polycondensation). On the other hand the term also embraces derivatives of such a collective of macromolecules from polymerization reactions, in other words compounds which have been obtained by reactions, such as additions or substitutions, of functional groups on existing macromolecules and which may be chemically uniform or chemically nonuniform. The term, furthermore, also embraces what are called prepolymers, in other words reactive oligomeric preadducts whose functional groups have participated in the synthesis of macromolecules.

The term “polyurethane polymer” embraces all polymers which are prepared by the diisocyanate polyaddition process. This is also includes those polymers which are virtually or entirely free of urethane groups. Examples of polyurethane polymers are polyether-polyurethanes, polyester-polyurethanes, polyether-polyureas, polyureas, polyester-polyureas, polyisocyanurates, and polycarbodiimides.

“Room temperature” refers to a temperature of 25° C.

Substance names beginning with “poly”, such as polyaldimine, polyisocyanate, polyol or polyamine, in the present document identify substances which formally contain two or more per molecule of the functional groups that occur in their name.

The term “primary amino group” in the present document identifies an NH₂ group, which is attached to one organic radical, while the term “secondary amino group” identifies an NH group, which is attached to two organic radicals, which may also together be part of a ring.

An “aliphatic amino group” is an amino group which is attached to an aliphatic, cycloaliphatic or arylaliphatic radical. It therefore differs from an “aromatic amino group”, which is attached directly to an aromatic or heteroaromatic radical, such as in aniline or 2-aminopyridine, for example.

The moisture-reactive hotmelt adhesive composition comprises at least one polyurethane polymer P which is solid at room temperature and contains isocyanate groups.

A suitable polyurethane polymer P is obtainable through the reaction of at least one polyol with at least one polyisocyanate.

Suitable polyols are more particularly polyether polyols, polyester polyols, and polycarbonate polyols, and also mixtures of these polyols.

Suitable more particularly as polyether polyols, also called polyoxyalkylene polyols, are those which are polymerization products of ethylene oxide, 1,2-propylene oxide, 1,2- or 2,3-butylene oxide, tetrahydrofuran or mixtures thereof, optionally polymerized with the aid of a starter molecule having two or more active hydrogen atoms such as, for example, water, ammonia or compounds having two or more OH or NH groups such as, for example, 1,2-ethanediol, 1,2- and 1,3-propanediol, neopentylglycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the aforementioned compounds. Use may be made not only of polyoxyalkylene polyols which have a low degree of unsaturation (measured in accordance with ASTM D-2849-69 and reported in milliequivalents of unsaturation per gram of polyol (meq/g)), prepared with the aid for example of what are known as double metal cyanide complex catalysts (DMC catalysts), but also of polyoxyalkylene polyols having a higher degree of unsaturation, prepared with the aid for example of anionic catalysts such as NaOH, KOH or alkali metal alkoxides.

Particularly suitable polyether polyols are polyoxyalkylene diols and triols, especially polyoxyalkylene diols. Particularly suitable polyoxyalkylene diols and triols are polyoxyethylene diols and triols and also polyoxypropylene diols and triols.

Particularly suitable polyoxypropylene diols and triols are those having a degree of unsaturation of less than 0.02 meq/g and a molecular weight in the range from 1000 to 30 000 g/mol, and also polyoxypropylene diols and triols having a molecular weight of 400 to 8000 g/mol. By “molecular weight” or “molar weight”, in the present document is meant always the molecular weight average Mₙ. Especially suitable polyoxypropylene diols are those having a degree of unsaturation of less than 0.02 meq/g and a molecular weight in the range from 1000 to 12 000, more particularly between 1000 and 8000 g/mol. Polyether polyols of this kind are sold for example under the trade name Acclaim® by Bayer.

Likewise particularly suitable are what are called “EO-endcapped” (ethylene oxide-endcapped) polyoxypropylene diols and triols. The latter are special polyoxypropylene-polyoxyethylene polyols which are obtained, for example, by alkoxylating pure polyoxypropylene polyols with ethylene oxide after the end of the polypropoxylation, and which as a result contain primary hydroxyl groups.

Suitable polyester polyols are polyesters which carry at least two hydroxyl groups and are prepared by known processes, more particularly by the polycondensation of hydroxycarboxylic acids or the polycondensation of aliphatic and/or aromatic polycarboxylic acids with alcohols having a functionality of two or more.

Particularly suitable are polyester polyols which are prepared from dihydric to trihydric, especially dihydric, alcohols, such as, for example, ethylene glycol, diethylene glycol, propylene glycol, dipropylene glycol, neopentylglycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid diol (dimerdiol), hydroxypivalic acid neopentyl glycol ester, glycerol, 1,1,1-trimethylolpropane or mixtures of the aforementioned alcohols, with organic dicarboxylic or tricarboxylic acids, especially dicarboxylic acids, or their anhydrides or esters, such as, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid, and trimellitic anhydride, or mixtures of the aforementioned acids, and also polyester polyols formed from lactones such as, for example, from ε-caprolactone and starters such as the aforementioned dihydric or trihydric alcohols.

Particularly suitable polyester polyols are polyester diols. Especially suitable polyester diols are those prepared from adipic acid, azelaic acid, sebacic acid, dodecanedicarboxylic acid, dimer fatty acid, phthalic acid, isophthalic acid, and terephthalic acid as dicarboxylic acid and from ethylene glycol, diethylene glycol, neopentyl glycol, 1,4-butanediol, 1,6-hexanediol, dimer fatty acid diol, and 1,4-cyclohexanedimethanol as dihydric alcohol. Also especially suitable are polyester diols prepared from ε-caprolactone and one of the aforementioned dihydric alcohols as starter.

The polyester polyols advantageously have a molecular weight of 1000 to 15 000 g/mol, more particularly of 1500 to 8000 g/mol, more particularly of 1700 to 5500 g/mol.

Especially suitable are polyester diols and triols, especially polyester diols, that are crystalline, partly crystalline, amorphous, and liquid at room temperature. Suitable polyester polyols which are liquid at room temperature are solid not far below room temperature, at temperatures between 0° C. and 25° C., for example, and are used preferably in combination with at least one amorphous, partly crystalline or crystalline polyester polyol. Particular suitability is possessed by amorphous polyester diols, and also by mixtures of amorphous polyester diols and polyester diols which are liquid at room temperature.

Suitable polycarbonate polyols are those of the kind obtainable by polycondensation, for example, of the abovementioned dihydric or trihydric alcohols—those used to synthesize the polyester polyols—with dialkyl carbonates, such as dimethyl carbonate, diaryl carbonates, such as diphenyl carbonate, or phosgene.

Particular suitability is possessed by polycarbonate diols, especially amorphous polycarbonate diols.

Likewise suitable as polyols are block copolymers which carry at least two hydroxyl groups and contain at least two different blocks with polyether, polyester and/or polycarbonate structure of the type described above.

Preferred polyols are polyester polyols and polycarbonate polyols, especially polyester diols and polycarbonate diols.

Particular preference is given to amorphous polyester diols and amorphous polycarbonate diols, and also to mixtures of amorphous polyester or polycarbonate diols and polyester or polycarbonate diols which are liquid at room temperature.

The most preferred are polyester diols, especially amorphous polyester diols, and also mixtures of amorphous polyester diols and polyester diols which are liquid at room temperature.

As polyisocyanates for preparing a polyurethane polymer P it is possible to use commercial aliphatic, cycloaliphatic or aromatic polyisocyanates, especially diisocyanates, examples being the following:

1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,10-decamethylene diisocyanate, 1,12-dodecamethylene diisocyanate, lysine diisocyanate and lysine ester diisocyanate, cyclohexane 1,3- and 1,4-diisocyanate and any desired mixtures of these isomers, 1-methyl-2,4- and -2,6-diisocyanatocyclohexane and any desired mixtures of these isomers (HTDI or H₆TDI), 1-isocyanato-3,3,5-trimethyl-5-isocyanatomethylcyclohexane (i.e., isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl)naphthalene, 2,4- and 2,6-tolylene diisocyanate and any desired mixtures of these isomers (TDI), 4,4′-, 2,4′-, and 2,2′-diphenylmethane diisocyanate and any desired mixtures of these isomers (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatobiphenyl (TODI), dianisidine diisocyanate (DADI), oligomers and polymers of the aforementioned isocyanates, and also any desired mixtures of the aforementioned isocyanates. Preference is given to MDI, TDI, HDI, and IPDI. MDI and IPDI are particularly preferred.

The polyurethane polymer P is prepared in a known way directly from the polyisocyanates and the polyols, or by stepwise adduction processes, of the kind also known as chain extension reactions.

In one preferred embodiment the polyurethane polymer P is prepared via a reaction of at least one polyisocyanate and at least one polyol, the isocyanate groups being present in a stoichiometric excess over the hydroxyl groups. Advantageously the ratio between isocyanate groups and hydroxyl groups is 1.3 to 2.5, more particularly 1.5 to 2.2.

The polyurethane polymer P is solid at room temperature. In this context it may be crystalline, partly crystalline or amorphous. For a partly crystalline or amorphous polyurethane polymer P it is the case that it is not fluid, or has only little fluidity, at room temperature—this means, in particular, that it has a viscosity of more than 5000 Pa·s at 20° C.

The polyurethane polymer P has a molecular weight of preferably over 1000 g/mol, more particularly a molecular weight of between 1200 and 50 000 g/mol, preferably one of between 2000 and 30 000 g/mol.

The polyurethane polymer P additionally has preferably an average functionality in the range from 1.8 to 2.2.

The polyurethane polymer P which is solid at room temperature is preferably transparent. A transparent polyurethane prepolymer which is solid at room temperature is typically prepared using either amorphous polyols or a mixture of polyols that are amorphous and polyols that are liquid at room temperature.

Preferably the polyurethane polymer P amorphous. Moreover, the polyurethane polymer P is preferably transparent, both before and after chemical crosslinking with moisture.

Customarily the polyurethane polymer P is present in an amount of 40%-100% by weight, more particularly of 75%-100% by weight, preferably of 80%-100% by weight, based on the overall moisture-reactive hotmelt adhesive composition.

The moisture-reactive hotmelt adhesive composition comprises not only the polyurethane polymer P which is solid at room temperature and contains isocyanate groups but also a polyaldimine ALD of the formula (I a) or (I b),

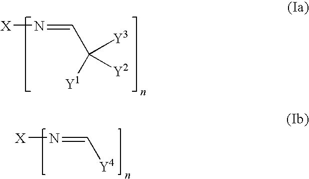

where X, n, Y¹, Y², Y³, and Y⁴ have the definitions already mentioned.

Preferably X is a hydrocarbon radical which is optionally substituted and which optionally contains heteroatoms, more particularly in the form of ether oxygen, tertiary amine nitrogen or thioether sulfur.

Preferably n is 2 or 3, more particularly 2.

Preferably Y¹ and Y² are each a methyl group.

Preferably Y³ is a radical of the formula (II) or (III)

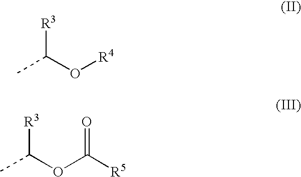

where R³ is a hydrogen atom or is an alkyl or arylalkyl group, preferably a hydrogen atom;
R⁴ is a hydrocarbon radical having 1 to 30, more particularly 12 to 30, C atoms, which optionally contains heteroatoms; and
R⁵ alternatively
is a hydrogen atom,
or is a linear or branched alkyl radical having 1 to 30, more particularly 11 to 30, C atoms, optionally with cyclic fractions and optionally with at least one heteroatom,
or is a singly or multiply unsaturated, linear or branched hydrocarbon radical having 5 to 30 C atoms, or is an optionally substituted aromatic or heteroaromatic, 5- or 6-membered ring.

The dashed lines in the formulae in this document represent in each case the bond between a substituent and the associated remainder of the molecule.

A polyaldimine ALD of the formula (I a) or (I b) is obtainable by a condensation reaction, with elimination of water, between a polyamine of the formula (IV) and an aldehyde of the formula (V a) or (V b). The aldehyde of the formula (V a) or (V b) is used here, in relation to the amino groups of the polyamine of the formula (IV), stoichiometrically or in a stoichiometric excess.

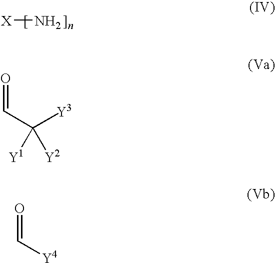

In the formulae (IV), (V a), and (V b), X, n and Y¹, Y², Y³, and Y⁴ have the definitions already mentioned.

Suitable polyamines of the formula (IV) are polyamines having aliphatic primary amino groups, examples being the following: aliphatic polyamines such as ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 1,6-hexamethylenediamine, 2,2,4- and 2,4,4-trimethylhexamethylenediamine and mixtures thereof, 1,7-heptanediamine, 1,8-octanediamine, 4-aminomethyl-1,8-octanediamine, 1,9-nonanediamine, 1,10-decanediamine, 1,11-undecanediamine, 1,12-dodecanediamine, methyl-bis(3-aminopropyl)amine, 1,5-diamino-2-methylpentane (MPMD), 1,3-diaminopentane (DAMP), 2,5-dimethyl-1,6-hexamethylenediamine, cycloaliphatic polyamines such as 1,3- and 1,4-diaminocyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, 1-amino-3-aminomethyl-3,5,5-trimethylcyclohexane (i.e., isophoronediamine or IPDA), 2- and 4-methyl-1,3-diaminocyclohexane and mixtures thereof, 1,3- and 1,4-bis(aminomethyl)cyclohexane), 1-cyclohexylamino-3-aminopropane, 2,5(2,6)-bis(aminomethyl)bicyclo[2.2.1]-heptane (NBDA, produced by Mitsui Chemicals), 3(4), 8(9)-bis(aminomethyl)tricyclo[5.2.1.0^{2,6}]decane, 1,4-diamino-2,2,6-trimethylcyclohexane (TMCDA), 3,9-bis(3-aminopropyl)-2,4,8,10-tetraoxaspiro[5.5]undecane, 1,3- and 1,4-xylylenediamine, aliphatic polyamines containing ether groups, such as bis(2-aminoethyl)ether, 4,7-dioxadecane-1,10-diamine, 4,9-dioxadodecane-1,12-diamine, and higher oligomers thereof, polyoxyalkylene-polyamines having two or three amino groups, obtainable for example under the name Jeffamine® (from Huntsman Chemicals), under the name Polyetheramin (from BASF) or under the name PC Amine® (from Nitroil), and also mixtures of the aforementioned polyamines.

Preferred polyamines of the formula (IV) are polyamines which are selected from the group consisting of 1,6-hexamethylenediamine, MPMD, DAMP, IPDA, 4-aminomethyl-1,8-octanediamine, 1,3-xylylenediamine, 1,3-bis(aminomethyl)cyclohexane, bis(4-aminocyclohexyl)methane, bis(4-amino-3-methylcyclohexyl)methane, 3(4),8(9)-bis(aminomethyl)tricyclo[5.2.1.0^{2,6}]decane, 1,4-diamino-2,2,6-trimethylcyclohexane, and polyoxyalkylene-polyamines having two or three amino groups, particularly the products EDR-148, D-230, D-400, D-2000, T-403, and T-5000 that are available under the trade name Jeffamine® from Huntsman, and analogous compounds to these, from BASF or Nitroil, and also their mixtures with one another.

A polyaldimine ALD of the formula (I a) or (I b) is prepared using aldehydes of the formula (V a) or (V b). A feature of these aldehydes is that their radicals Y¹, Y², Y³, and Y⁴ contain no moieties which in the absence of water are reactive with isocyanate groups; in particular, Y¹, Y², Y³, and Y⁴ contain no hydroxyl groups, no primary or secondary amino groups, no urea groups, and no other groups with active hydrogen.

Suitable first for preparing a polyaldimine ALD are aldehydes of the formula (V a), where Y¹, Y², and Y³ have the definitions already stated.

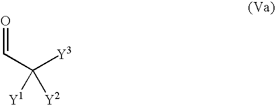

Aldehydes of the formula (V a) are tertiary aliphatic or tertiary cycloaliphatic aldehydes, such as pivalaldehyde (i.e., 2,2-dimethylpropanal), 2,2-dimethylbutanal, 2,2-diethylbutanal, 1-methylcyclopentanecarboxaldehyde, 1-methylcyclohexanecarboxaldehyde, for example; and also ethers of 2-hydroxy-2-methylpropanal and alcohols such as propanol, isopropanol, butanol, and 2-ethylhexanol; esters of 2-formyl-2-methylpropionic acid or 3-formyl-3-methylbutyric acid and alcohols such as propanol, isopropanol, butanol, and 2-ethylhexanol; esters of 2-hydroxy-2-methylpropanal and carboxylic acids such as butyric acid, isobutyric acid, and 2-ethylhexanoic acid; and also the ethers and esters, described below as being particularly suitable, of 2,2-disubstituted 3-hydroxypropanals, -butanals or analogous higher aldehydes, especially of 2,2-dimethyl-3-hydroxypropanal.

Particularly suitable aldehydes of the formula (V a) are in a first embodiment aldehydes of the formula (VI), i.e, aldehydes of the formula (V a) with the radical Y³ of the formula (II)

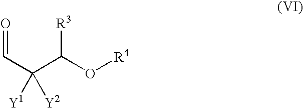

where
R³ is a hydrogen atom or an alkyl or arylalkyl group,
R⁴ is a hydrocarbon radical having 1 to 30 C atoms which optionally contains heteroatoms, and
Y¹ and Y² have the definitions already stated.

In formula (VI) Y¹ and Y² are each preferably a methyl group, and R³ is preferably a hydrogen atom.

Aldehydes of the formula (VI) represent ethers of aliphatic, araliphatic or cycloaliphatic 2,2-disubstituted 3-hydroxyaldehydes with alcohols of the formula HO—R⁴, fatty alcohols, for example. Suitable 2,2-disubstituted 3-hydroxyaldehydes are in turn obtainable from aldol reactions, especially crossed aldol reactions, between primary or secondary aliphatic aldehydes, especially formaldehyde, and secondary aliphatic, secondary araliphatic or secondary cycloaliphatic aldehydes, such as, for example, 2-methylbutyraldehyde, 2-ethylbutyraldehyde, 2-methylvaleraldehyde, 2-ethylcaproaldehyde, cyclopentane-carboxaldehyde, cyclohexanecarboxaldehyde, 1,2,3,6-tetrahydrobenzaldehyde, 2-methyl-3-phenylpropionaldehyde, 2-phenylpropionaldehyde (hydratropaldehyde) or diphenylacetaldehyde.

Examples of such aldehydes of the formula (VI) include 2,2-dimethyl-3-(2-ethylhexyloxy)propanal, 2,2-dimethyl-3-lauroxypropanal, and 2,2-dimethyl-3-stearoxypropanal.

In a second embodiment particularly suitable aldehydes of the formula (V a) are aldehydes of the formula (VII), i.e., aldehydes of the formula (V a) with the radical Y³ of the formula (III).

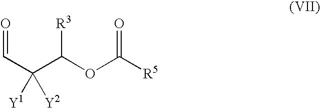

In formula (VII)

R³ is a hydrogen atom or an alkyl or arylalkyl group;
R⁵ is alternatively
a hydrogen atom,
or a linear or branched alkyl radical having 1 to 30 C atoms, optionally with cyclic fractions and optionally with at least one heteroatom,
or a singly or multiply unsaturated, linear or branched hydrocarbon radical having 5 to 30 C atoms,
or an optionally substituted aromatic or heteroaromatic, 5- or 6-membered ring;
   and Y¹ and Y² have the definitions already stated.

In formula (VII) Y¹ and Y² are each preferably a methyl group, and R³ is preferably a hydrogen atom.

Compounds of the formula (VII) represent esters of the above-described 2,2-disubstituted 3-hydroxyaldehydes, such as, for example, 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde, 1-hydroxymethylcyclohex-3-enecarboxaldehyde, 2-hydroxymethyl-2-methyl-3-phenylpropanal, 3-hydroxy-2-methyl-2-phenylpropanal, and 3-hydroxy-2,2-diphenylpropanal, with suitable carboxylic acids.

Examples of suitable carboxylic acids are first aliphatic carboxylic acids, such as formic acid, acetic acid, propionic acid, butyric acid, isobutyric acid, valeric acid, caproic acid, 2-ethylcaproic acid, capric acid, lauric acid, tridecanoic acid, myristic acid, pentadecanoic acid, palmitic acid, margaric acid, stearic acid, nonadecanoic acid, arachidic acid, palmitoleic acid, oleic acid, erucic acid, linoleic acid, linolenic acid, eleostearic acid, arachidonic acid, fatty acids from the industrial saponification of natural oils and fats such as, for example, rapeseed oil, sunflower oil, linseed oil, olive oil, coconut oil, oil palm kernel oil, and oil palm oil, and also industrial mixtures of fatty acids which comprise such acids. Suitable carboxylic acids are secondly aromatic carboxylic acids, examples being benzoic acid or the positionally isomeric tolylic acids, ethyl- or isopropyl- or tert-butyl- or methoxy- or nitrobenzoic acids.

Preferred aldehydes of the formula (VII) are 2,2-dimethyl-3-lauroyloxypropanal, 2,2-dimethyl-3-myristoyloxypropanal, 2,2-dimethyl-3-palmitoyloxypropanal, 2,2-dimethyl-3-stearoyloxypropanal, and 2,2-dimethyl-3-benzoyloxypropanal, and also analogous esters of other 2,2-disubstituted 3-hydroxyaldehydes.

In one particularly preferred embodiment R⁵ is selected from the group consisting of phenyl and the C₁₁, C₁₃, C₁₅, and C₁₇ alkyl groups.

A particularly preferred aldehyde of the formula (VII) is 2,2-dimethyl-3-lauroyloxypropanal.

In one preferred preparation method of the aldehyde of the formula (VII) a 2,2-disubstituted 3-hydroxyaldehyde, 2,2-dimethyl-3-hydroxypropanal, for example, which can be prepared, for example, from formaldehyde (or paraformaldehyde) and isobutyraldehyde, where appropriate in situ, is reacted with a carboxylic acid to give the corresponding ester. This esterification can take place without the use of solvents by known methods, described, for example, in Houben-Weyl, “Methoden der organischen Chemie”, Vol. VIII, pages 516-528.

In one particularly preferred embodiment the aldehyde of the formula (V a) is odorless. By an “odorless” substance is meant a substance whose odor is so low that it can no longer be smelt by the majority of human individuals, i.e., is not perceptible with the nose.

Odorless aldehydes of the formula (V a) are on the one hand, in particular, aldehydes of the formula (VI) in which the radical R⁴ is a hydrocarbon radical having 12 to 30 C atoms, which optionally contains heteroatoms.

On the other hand, odorless aldehydes of the formula (V a) are more particularly aldehydes of the formula (VII), in which the radical R⁵ is either a linear or branched alkyl group having 11 to 30 carbon atoms, optionally with cyclic fractions, and optionally with at least one heteroatom, more particularly with at least one ether oxygen, or a singly or multiply unsaturated linear or branched hydrocarbon chain having 11 to 30 carbon atoms.

Examples of odorless aldehydes of the formula (VII) are esterification products of the aforementioned 2,2-disubstituted 3-hydroxyaldehydes with carboxylic acids such as, for example, lauric acid, tridecanoic acid, myristic acid, pentadecanoic acid, palmitic acid, margaric acid, stearic acid, nonadecanoic acid, arachidic acid, palmitoleic acid, oleic acid, erucic acid, linoleic acid, linolenic acid, eleostearic acid, arachidonic acid, fatty acids from the industrial saponification of natural oils and fats, such as rapeseed oil, sunflower oil, linseed oil, olive oil, coconut oil, oil palm kernel oil, and oil palm oil, for example, and also industrial mixtures of fatty acids which comprise these acids. Preferred aldehydes of the formula (VII) are 2,2-dimethyl-3-lauroyloxypropanal, 2,2-dimethyl-3-myristoyloxypropanal, 2,2-dimethyl-3-palmitoyloxypropanal, and 2,2-dimethyl-3-stearoyloxypropanal. 2,2-dimethyl-3-lauroyloxypropanal is particularly preferred.

Secondly suitable for preparing a polyaldimine ALD are aldehydes of the formula (V b)

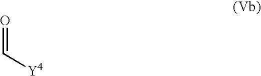

where Y⁴ alternatively
is a substituted or unsubstitued aryl or heteroaryl group which has a ring size of between 5 and 8, preferably 6, atoms
or is

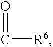

where R⁶ is a hydrogen atom or is an alkoxy group,
or is a substituted or unsubstituted alkenyl or arylalkenyl group having at least 6 C atoms.

Suitable aldehydes of the formula (V b) are aromatic aldehydes, such as, for example, benzaldehyde, 2- and 3- and 4-tolualdehyde, 4-ethyl- and 4-propyl- and 4-isopropyl- and 4-butyl-benzaldehyde, 2,4-dimethylbenzaldehyde, 2,4,5-trimethylbenzaldehyde, 4-acetoxybenzaldehyde, 4-anisaldehyde, 4-ethoxybenzaldehyde, the isomeric di- and trialkoxybenzaldehydes, 2-, 3-, and 4-nitrobenzaldehyde, 2- and 3- and 4-formylpyridine, 2-furfuraldehyde, 2-thiophenecarbaldehyde, 1- and 2-naphthylaldehyde, 3- and 4-phenyloxybenzaldehyde; quinoline-2-carbaldehyde and its 3-, 4-, 5-, 6-, 7-, and 8-position isomers, and also anthracene-9-carbaldehyde.

Suitable aldehydes of the formula (V b) are additionally glyoxal, glyoxalic esters, methyl glyoxalate, for example, and cinnamaldehyde and substituted cinnamaldehydes.

A feature of the polyaldimines ALD of the formula (I a) with aliphatic aldimine groups and of the polyaldimines ALD of the formula (I b) with aromatic aldimine groups is that their aldimine groups are unable to undergo tautomerization to form enamine groups, since they do not contain a hydrogen as a substituent in the α-position with respect to the C atom of the aldimine group. On account of this feature, together with polyurethane polymers P containing isocyanate groups, they form mixtures which are particularly storage-stable, i.e., largely viscosity-stable, even in the presence of highly reactive aromatic isocyanate groups such as those of TDI and MDI.

Polyaldimines ALD which are prepared starting from odorless aldehydes of the particularly preferred embodiment described above are odorless. Odorless polyaldimines ALD of this kind are particularly preferred.

Preferred polyaldimines ALD are those which have the formula (I a).

Under suitable conditions, more particularly in the absence of moisture, the polyaldimines ALD are storage-stable. On ingress of moisture, their aldimine groups may undergo formal hydrolysis, via intermediates, to amino groups, in which case the corresponding aldehyde of the formula (V a) or (V b) used in preparing, the aldimine is released. Since this hydrolysis reaction is reversible and since the chemical equilibrium lies significantly on the aldimine side, it is assumed that, in the absence of groups that are reactive toward amines, only some of the aldimine groups undergo partial or complete hydrolysis.

In the presence of isocyanate groups, the hydrolyzing aldimine groups react with the isocyanate groups to form urea groups. The reaction of the isocyanate groups with the hydrolyzing aldimine groups need, not necessarily be via free amino groups. Reactions with intermediates of the hydrolysis reaction are of course also possible. For example, it is conceivable for a hydrolyzing aldimine group in the form of a hemiaminal to react directly with an isocyanate group.

A polyaldimine ALD in the moisture-reactive hotmelt adhesive composition is present preferably in a slightly superstoichiometric, a stoichiometric or a substoichiometric amount, relative to all of the free isocyanate groups. Advantageously the ratio between aldimine groups and isocyanate groups is 0.1 to 1.1, more particularly 0.15 to 1.0, more preferably 0.2 to 0.9, equivalent of aldimine groups per equivalent of isocyanate groups.

As polyaldimine ALD it is also possible to use mixtures of different polyaldimines ALD. In particular it is possible to use mixtures of different polyamines ALD which have been prepared starting from mixtures of different polyamines of the formula (IV) and/or mixtures of different aldehydes of the formula (V a) or (V b). It may be particularly advantageous to use, as polyaldimine ALD, mixtures of polyaldimines ALD which have been prepared starting from mixtures consisting of diamines and triamines of the formula (IV).

The moisture-reactive hotmelt adhesive composition comprises, in addition to the polyurethane polymer P that is solid at room temperature and contains isocyanate groups, and the polyaldimine ALD of the formula (I a) or (I b), additionally at least one acid K in the form of an organic monocarboxylic or dicarboxylic acid or of an organic monosulfonic or disulfonic acid or of a compound which can be hydrolyzed to one of these acids.

In a first embodiment the acid K is an organic monocarboxylic or dicarboxylic acid or a compound which can be hydrolyzed to an organic monocarboxylic or dicarboxylic acid, and is selected, for example, from
saturated aliphatic monocarboxylic acids such as formic acid, acetic acid, propionic acid, butyric acid, isobutyric acid, valeric acid, isovaleric acid, pivalic acid, caproic acid, enanthic acid, caprylic acid, 2-ethylhexanoic acid, pelargonic acid, capric acid, neodecanoic acid, undecanoic acid, lauric acid, tridecanoic acid, myristic acid, pentadecanoic acid, palmitic acid, margaric acid, stearic acid, isostearic acid, arachidic acid, and behenic acid;
saturated aliphatic dicarboxylic acids such as oxalic acid, malonic acid, succinic acid, glutaric acid, adipic acid, pimelic acid, suberic acid, azelaic acid, sebacic acid, and dodecanedioic acid;
mono- or polyunsaturated aliphatic monocarboxylic or dicarboxylic acids such as palmitoleic acid, oleic acid, erucic acid, sorbic acid, linoleic acid, linolenic acid, eleostearic acid, ricinoleic acid, ricinenic acid, maleic acid, fumaric acid, and sorbic acid;
cycloaliphatic monocarboxylic or dicarboxylic acids such as cyclohexanecarboxylic acid, hexahydrophthalic acid, tetrahydrophthalic acid, resin acids, and naphthenic acids;
halogenated aliphatic monocarboxylic or dicarboxylic acids such as trichloroacetic acid and 2-chloropropionic acid;
aromatic monocarboxylic or dicarboxylic acids such as benzoic acid, salicylic acid, gallic acid, phthalic acid, terephthalic acid, isophthalic acid, and the positionally isomeric tolylic acids, methoxybenzoic acids, chlorobenzoic acids, and nitrobenzoic acids;
industrial carboxylic acid mixtures such as, for example, Versatic® acids;
carboxylic anhydrides such as phthalic anhydride and hexahydrophthalic anhydride;
silyl esters of the stated organic carboxylic acids, examples being silicon tetraacetate, trimethylsilyl acetate, triacetoxyethyl acetate, trimethylsilyl laurate, and trimethylsilyl benzoate.

In a second embodiment the acid K is an organic monosulfonic or disulfonic acid or a compound which can be hydrolyzed to an organic monosulfonic or disulfonic acid, selected, for example, from
aliphatic or aromatic monosulfonic and disulfonic acids such as methylsulfonic acid, vinylsulfonic acid, butylsulfonic acid, sulfoacetic acid, benzenesulfonic acid, the positionally isomeric benzenedisulfonic acids, p-toluenesulfonic acid, p-xylenesulfonic acid, 4-dodecylbenzenesulfonic acid, 1-naphthalenesulfonic acid, dinonylnaphthalenesulfonic acid, and dinonylnaphthalenedisulfonic acid;
alkyl or silyl esters of the stated monosulfonic or disulfonic acids, examples being methyl p-toluenesulfonate, ethylene glycol bis-p-toluenesulfonate, trimethylsilyl methanesulfonate, and trimethylsilyl benzenesulfonate;
sultones and anhydrides, examples being 1,4-butane sultone and 2-sulfobenzoic anhydride.

The acid K may also comprise mixtures of two or more of the stated acids or compounds which can be hydrolyzed to these acids.

Preferred as acid K are aromatic monocarboxylic acids, especially benzoic acid, salicylic acid, and 2-nitrobenzoic acid.

Customarily the acid K is present in an amount of 0.001% to 5% by weight, preferably 0.005% to 2% by weight, based on the overall moisture-reactive hotmelt adhesive composition.

The acid K has a catalytic effect on the hydrolysis of the polyaldimine ALD, which accelerates the chemical crosslinking of the moisture-reactive hotmelt adhesive composition.

The above-described moisture-reactive hotmelt adhesive composition comprises, if desired, further constituents, of the type customarily used in accordance with the prior art. To the person skilled in the art it is clear in this context that such further constituents must be chosen, as a function of the respective composition and in terms of their nature and amount, in such a way that the composition remains storage-stable in spite of their presence.

Where appropriate the above-described moisture-reactive hotmelt adhesive composition comprises nonreactive thermoplastic polymers, such as, for example, homopolymers or copolymers of unsaturated monomers, particularly from the group encompassing ethylene, propylene, butylene, isobutylene, isoprene, vinyl acetate or higher esters thereof, and (meth)acrylate. Particularly suitable are ethylene-vinyl acetate copolymers (EVA), atactic poly-α-olefins (APAO), polypropylenes (PP), and polyethylenes (PE).

If appropriate the moisture-reactive hotmelt adhesive composition described comprises catalysts for the reaction of the isocyanate groups, such as metal compounds or tertiary amines.

Suitable metal compounds are, for example, tin compounds such as dibutyltin diacetate, dibutyltin dilaurate, dibutyltin distearate, dibutyltin diacetylacetonate, dioctyltin dilaurate, dibutyltin dichloride, dibutyltin oxide, and tin(II) carboxylates; stannoxanes such as laurylstannoxane; and bismuth compounds such as bismuth(III) octoate, bismuth(III) neodecanoate or bismuth(III) oxinates.

Suitable tertiary amines are, for example, 2,2′-dimorpholinodiethyl ether and other morpholine ether derivatives, 1,4-diazabicyclo[2.2.2]octane, and 1,8-diazabicyclo[5.4.0]undec-7-ene.

The moisture-reactive hotmelt adhesive composition may also comprise mixtures of the stated catalysts. Mixtures of metal compounds and tertiary amines are particularly suitable.

If appropriate the above-described moisture-reactive hotmelt adhesive composition comprises reactive diluents or crosslinkers, examples being oligomers or polymers of diisocyanates such as MDI, PMDI, TDI, HDI, 1,12-dodecamethylene diisocyanate, cyclohexane 1,3- or 1,4-diisocyanate, IPDI, perhydro-2,4′- and -4,4′-diphenylmethane diisocyanate, 1,3- and 1,4-tetramethylxylylene diisocyanate, especially isocyanurates, carbodiimides, uretonimines, biurets, allophanates, and iminooxadiazinediones of the stated diisocyanates, adducts of polyisocyanates with short-chain polyols, and also adipic dihydrazide and other dihydrazides, and also further polyaldimines, more particularly those obtained from the reaction of polyamines of the formula (IV) with dialdehydes.

The above-described moisture-reactive hotmelt adhesive composition may further comprise other additions, such as, in particular, fillers, plasticizers, adhesion promoters, especially compounds containing silane groups, UV absorbers, UV stabilizers or heat stabilizers, antioxidants, flame retardants, optical brighteners, pigments, dyes, and drying agents, and also further substances customarily used in isocyanate compositions.

In one preferred embodiment the above-described moisture-reactive hotmelt adhesive composition is free of carbon black.

In another preferred embodiment the above-described moisture-reactive hotmelt adhesive composition is entirely free of fillers.

In one particularly preferred embodiment the above-described moisture-reactive hotmelt adhesion composition is transparent. More particularly it is transparent both before and after chemical crosslinking with moisture. A composition of this kind is especially suitable for the adhesive bonding of substrates in which at least one of the substrates to be adhesively bonded is transparent or translucent.

The above-described moisture-reactive hotmelt adhesive composition is produced and stored in the absence of moisture. In a suitable pack or facility impervious to ambient conditions, such as in a drum, pouch or cartridge, for example, its storage stability is outstanding. The terms “storage-stable” and “storage stability” in connection with a composition refer in the present document to the fact that the viscosity of the composition at the application temperature, given suitable storage, does not increase within the time span under consideration, or during that time increases only to such an extent that the composition remains suitable for use in the manner intended.

For the mode of action of a reactive hotmelt adhesive it is important that the adhesive can be melted, in other words that at the application temperature it has a sufficiently low viscosity in order to be able to be applied, and that on cooling it very quickly develops a sufficient bond strength even before the crosslinking reaction with atmospheric moisture is concluded (initial strength). It has emerged that at the application temperature, which for hotmelt adhesives is in the range from 80° C. to 200° C., typically from 120° C. to 160° C., the compositions described exhibit a readily manageable viscosity, and that on cooling they develop good bond strength with sufficient rapidity. A readily manageable viscosity is understood in particular to be a viscosity of 1-50 Pas.

On application, the above-described moisture-reactive hotmelt adhesive composition comes into contact with moisture, particularly in the form of atmospheric moisture. The physical hardening as a result of solidification on cooling is accompanied in parallel by the onset of chemical crosslinking with moisture, primarily through hydrolysis of the aldimine groups present, as a result of moisture, and rapid reaction with extant isocyanate groups in the manner already described. Excess isocyanate groups likewise crosslink with moisture in a known way.

The terms “crosslinking”, “chemical crosslinking”, and “crosslinking reaction” are understood throughout the document to refer to the process, initiated by the chemical reaction of isocyanate groups, in which high molecular mass polyurethane polymers come about, even when the resulting network is not covalently bonded. If the crosslinking reaction in a moisture-reactive hotmelt adhesive composition has progressed through the entire mass, the term “through-curing” is also used.

The moisture needed for crosslinking may come either from the air (atmospheric moisture), or else the composition may be contacted with a water-containing component, by spread-coating or by spraying, for example, or else the composition may be admixed on application with a water-containing component, in the form, for example, of a hydrous paste which is mixed in, for example, via a static mixer.

On crosslinking with moisture, the above-described moisture-reactive hotmelt adhesive composition displays a greatly reduced tendency to form bubbles, since the crosslinking reaction produces less carbon dioxide or none at all, as a result of the presence of aldimine groups, depending on stiochiometry.

Moreover, the above-described moisture-reactive hotmelt adhesive composition exhibits a relatively rapid chemical crosslinking, even when the composition is amorphous and/or has been applied in a thick layer.

In one preferred embodiment the above-described moisture-reactive hotmelt adhesive composition is transparent. A composition of this kind comprises at least one transparent polyurethane polymer P, typically obtainable by reaction of at least one amorphous polyol, more particularly at least one amorphous polyester polyol or polycarbonate polyol, with a polyisocyanate in the manner already described. A transparent moisture-reactive hotmelt adhesive composition is especially suitable for the adhesive bonding of transparent substrates, where the bond site is visible.

Amorphous, or transparent, PUR-RHM which crosslink only by the reaction of isocyanate groups with water exhibit a very strong tendency to form bubbles and exhibit very slow crosslinking, particularly when applied in relatively thick layers. The reason for this is probably that the amorphous adhesive skin that forms from the surface on chemical crosslinking with moisture is particuluarly impermeable to gas, and hardly allows the passage either of the carbon dioxide from the inside that forms on crosslinking, or of the moisture from the outside that is needed for crosslinking.

In terms of bubble formation and rate of chemical crosslinking, the behavior of the above-described moisture-reactive hotmelt adhesive compositions is particularly advantageous. As a result of the presence of at least one polyaldimine ALD of the formula (I a) or (I b), the crosslinking with moisture on the one hand produces less CO₂ or none at all, which reduces the formation of bubbles; on the other hand, the rate of crosslinking is significantly increased, probably due to the rapid reaction of the aldimine and to improved transport of moisture through the adhesive skin. Accordingly it is possible to apply such transparent moisture-reactive hotmelt adhesive compositions in relatively thick layers, such as in layer thicknesses of more than 500 micrometers, more particularly more than 800 micrometers through to several millimeters, for example, without excessive formation of bubbles on crosslinking, and without the crosslinking becoming excessively slow.

In application, the above-described moisture-reactive hotmelt adhesive composition is used for adhesively bonding a substrate S1 and a substrate S2.

One such method of adhesively bonding a substrate S1 and a substrate S2 comprises the steps of
i) heating the above-described moisture-reactive hotmelt adhesive composition to a temperature between 80° C. and 200° C., more particularly between 120° C. and 160° C.;
ii) applying the heated composition to a substrate S1;
iii) contacting the applied composition with a substrate S2;
   the substrate S2 being composed of the same or a different material to the substrate S1.

Step iii) is typically followed by a step iv) of chemically crosslinking the composition with moisture. The person skilled in the art understands that, depending on the system used, the temperature, and the reactivity of the composition, the crosslinking reaction may even begin during application. The major part of the crosslinking, however, takes place after application, and hence primarily in the solid aggregate state of the polyurethane polymer P, or of the adhesive.

Where necessary, the substrates S1 and/or S2 may be pretreated prior to application of the composition. Such pretreatments encompass, in particular, physical and/or chemical cleaning and activation processes, examples being abrading, sandblasting, brushing, corona treatment, plasma treatment, flame treatment, partial etching or the like, or treatment with cleaners or solvents, or the application of an adhesion promoter, an adhesion-promoter solution or a primer.

The substrates S1 and S2 may represent a multiplicity of materials. Particularly suitable are plastics, organic materials such as leather, fabrics, paper, wood, resin-bound woodbase materials, resin-textile composite materials, glass, porcelain, ceramic, and also metals and metal alloys, more particularly painted or powder-coated metals and metal alloys.

Particularly suitable plastics include polyvinyl chloride (PVC), acrylonitrile-butadiene-styrene copolymers (ABS), SMC (sheet molding composites), polycarbonate (PC), polyamide (PA), polyesters, polyoxymethylene (POM), polyolefins (PO), especially polyethylene (PE), polypropylene (PP), ethylene/propylene copolymers (EPM) and ethylene/propylene-diene terpolymers (EPDM), preferably PP or PE surface-treated by plasma, corona or flaming.

Considered preferred materials for the substrates S1 and/or S2 are transparent materials, especially transparent polymeric films. Another preferred transparent material is glass, particularly in the form of a glazing sheet.

The thickness of the adhesive in the bond (bond thickness) is typically 10 micrometers or more. More particularly the bond thickness is between 10 micrometers and 2 millimeters, especially between 80 micrometers and 500 micrometers.

The above-described moisture-reactive hotmelt adhesive composition is used in particular in an industrial manufacturing operation.

The composition is suitable in particular for bonds in which the bond site is visible. Thus it is suitable on the one hand in particular for the adhesive bonding of glass, particularly in vehicle construction and window construction. On the other hand it is particularly suitable for the adhesive bonding of clear-view packaging.

The adhesive bonding method results in articles. Such articles are, in particular, articles from the transport, furniture, textile or packaging sector. A preferred sector of the transport sector is the automobile sector in particular.

Exemplary articles of this kind are interior automobile trim parts, such as roof linings, sun visors, instrument panels, door side part, parcel shelf, and the like; wood fiber materials from the bath and shower sector; decorative foils for furniture, membrane films with textiles such as cotton, polyester films in the clothing sector, or textiles with foams for automotive trim.

Further such articles, in particular, articles from the packaging sector. An article of this kind is more particularly a clear-view pack.

The above-described moisture-reactive hotmelt adhesive composition, comprising
a) at least one polyurethane polymer P which is solid at room temperature and contains isocyanate groups,
b) at least one polyaldimine ALD of the formula (I a) or (I b), and
c) at least one acid K in the form of an organic monocarboxylic or dicarboxylic acid or of an organic monosulfonic or disulfonic acid or of a compound which can be hydrolyzed to one of these acids, has a range of advantages over the prior art.

For instance, it has outstanding heat stability—that is, the viscosity is increased only slightly or not at all over time at a given application temperature. Moreover, it has a greatly reduced tendency to form bubbles, and exhibits a significantly higher crosslinking rate in comparison to systems which crosslink only via the reaction of isocyanate groups with water. Besides these advantages, the moisture-reactive hotmelt adhesive composition described exhibits properties which are of a similar quality to those of the prior-art systems: a rapid bond strength, high heat stability, and a high ultimate strength in combination with good extensibility, it being possible for the ultimate mechanical properties to be adapted within a very broad range to the requirements of an adhesive application.

In one particularly preferred embodiment it is odorless.

In another particularly preferred embodiment it is amorphous, more particularly transparent.

In a further aspect the invention provides a method of reducing bubble formation and of accelerating the chemical crosslinking of amorphous, more particularly transparent, moisture-reactive hotmelt adhesive compositions, by admixing at least one amorphous polyurethane polymer P as already described above, at least one polyaldimine ALD of the formula (I a) or (I b) as already described above, and at least one acid K in the form of an organic monocarboxylic acid or dicarboxylic acid or of an organic monosulfonic acid or disulfonic acid or of a compound which can be hydrolyzed to one of these acids, as already described above.

### EXAMPLES

### Description of the Test Methods

The total amount of aldimino groups and free amino groups in the compounds prepared (“amine content”) was determined by titrimetry (with 0.1N HClO₄ in glacial acetic acid, against crystal violet) and is always reported in mmol NH₂/g (even when the groups concerned are not only primary amino groups).

The viscosity was measured at the stated temperature with a Brookfield viscometer, using spindle No. 27, at 5 revolutions per minute.

The through-cure time was determined as follows: the respective hotmelt adhesive was applied at 150° C. to silicone paper to give a 60×500 mm strip of adhesive with a thickness of 500 micrometers. This sample was stored at 23° C. and 55% relative humidity. At regular intervals a section of this strip was cut off and placed on a hotplate with a temperature of 150° C. When the adhesive no longer melted, it was taken to have cured through. The through-cure time is a measure of the rate of chemical crosslinking.

The tensile strength and the elongation at break were determined in a method based on DIN 53504, on dumbbells with a thickness of 2 mm and a length of 75 mm (interconnect length 30 mm, interconnect width 4 mm). For producing the dumbbells a film of adhesive with a thickness of 2 mm was prepared (application temperature of the adhesive: 150° C.), from which the dumbbells were punched out and then stored for two weeks at 23° C. and 50% relative humidity.

The remaining tensile extension was tested on the dumbbells used for measuring the tensile strength and elongation at break. 1 minute after the release of load, the ruptured dumbbell was reassembled, its length was measured, and from this figure the initial length of 75 mm was deducted. The tensile extension is a measure of the resilience of the adhesive: the lower the remaining tensile extension, the better the resilience.

The formation of bubbles was determined visually on cylindrical test specimens with a diameter of 25 mm and a thickness of 2 mm, which were produced at an adhesive temperature of 150° C. and then stored for 2 weeks at 23° C. and 50% relative humidity.

### a) Preparation of the Polyaldimines ALD

### Polyaldimine ALD-1

A round-bottom flask was charged under a nitrogen atmosphere with 625 g (2.20 mol) of 2,2-dimethyl-3-lauroyloxypropanal. With vigorous stirring, slowly from a dropping funnel, 250 g (2.10 mol NH₂) of Jeffamine® D-230 (Huntsman; alpha,omega-polyoxypropylenediamine, amine equivalent weight 119 g/eq) were added. Thereafter, at 80° C., the volatile constituents were distilled off completely under reduced pressure. This gave 837 g of yellowish reaction product which is liquid at room temperature and has an aldimine content, determined as the amine content, of 2.5 mmol NH₂/g.

### Polyaldimine ALD-2

A round-bottom flask was charged under a nitrogen atmosphere with 298.7 g (1.05 mol) of 2,2-dimethyl-3-lauroyloxypropanal. With vigorous stirring, slowly from a heated dropping funnel, 58.1 g (0.50 mol) of 1,6-hexamethylenediamine were added. Thereafter, at 80° C., the volatile constituents were distilled off completely under reduced pressure. This gave 338.2 g of yellowish reaction product which is liquid at room temperature and has an aldimine content, determined as the amine content, of 2.94 mmol NH₂/g.

### Polyaldimine ALD-3

A round-bottom flask was charged under a nitrogen atmosphere with 625 g (2.20 mol) of 2,2-dimethyl-3-lauroyloxypropanal. With vigorous stirring, slowly from a dropping funnel, 334.2 g (2.10 mol NH₂) of Jeffamine®T-403 (Huntsman; polyoxypropylenetriamine, amine equivalent weight 159 g/eq) were added. Thereafter, at 80° C., the volatile constituents were distilled off completely under reduced pressure. This gave 921 g of yellowish reaction product which is liquid at room temperature and has an aldimine content, determined as the amine content, of 2.28 mmol NH₂/g.

### b) Preparation of a Polyurethane Polymer P

1000 g of Dynacoll® 7250 polyol (polyester diol, OH number 21 mg KOH/g, liquid at room temperature; Degussa), 1000 g of Dynacoll® 7150 polyol (polyester diol, OH number 42 mg KOH/g, solid at room temperature, amorphous, softening point 95° C.; Degussa), and 281 g of 4,4′-methylenediphenyl diisocyanate (MDI; Desmodur® 44 MC L, Bayer) were reacted by a known process at 140° C. to give an NCO-terminated polyurethane polymer. The reaction product had a free isocyanate group content, determined by titrimetry, of 2.0% by weight and was solid at room temperature. It was stored in the absence of moisture.

### c) Preparation of Hotmelt Adhesives

### Example 1

parts by weight (PBW) of the above-described polyurethane polymer P, 5 PBW of polyaldimine ALD-1, and 0.05 PBW of benzoic acid were mixed homogeneously at a temperature of 140° C. and stored in the absence of moisture.

### Example 2

parts by weight (PBW) of the above-described polyurethane polymer P, 5 PBW of polyaldimine ALD-2, and 0.05 PBW of benzoic acid were mixed homogeneously at a temperature of 140° C. and stored in the absence of moisture.

### Example 3

95 parts by weight (PBW) of the above-described polyurethane polymer P, 5 PBW of polyaldimine ALD-3, and 0.05 PBW of benzoic acid were mixed homogeneously at a temperature of 140° C. and stored in the absence of moisture.

### Example 4

### Comparative

As example 4 the above-described polyurethane polymer P was used, i.e., without addition of a polyaldimine ALD and of an acid.

TABLE 1
Properties of examples 1 to 3 and of
comparative example 4.

| | Example | | | |
|---|---|---|---|---|
| | | | | 4 |
| | 1 | 2 | 3 | (comp.) |
| Viscosity at 130° C. [Pa · s] | 15 | 16 | 21 | 14.5 |
| Through-cure time | 18 h | 22 h | 24 h | 48 h |
| Tensile strength [Mpa] | 34 | 30 | 31 | n.d.^{a} |
| Elongation at break [%] | 450 | 475 | 415 | n.d.^{a} |
| Remaining tensile extension | 5.5 mm | 3.5 mm | 8.5 mm | 10 mm |
| Formation of bubbles | few | few | few | very |
| | | | | many, |
| | | | | foam |

^{a}n.d. = not determinable, on account of excessive bubbles in the film

The results of table 1 show that the hotmelt adhesives of inventive examples 1, 2, and 3 exhibit a much shorter through-cure time, in other words a higher crosslinking rate, and greatly reduced formation of bubbles, in comparison to the hotmelt adhesive of comparative example 4. Moreover, the hotmelt adhesives of inventive examples 1, 2, and 3 also exhibit a lower remaining tensile extension, and hence a better resilience, than the hotmelt adhesive of comparative example 4.

1. A moisture-reactive hotmelt adhesive composition comprising
a) at least one polyurethane polymer P which is solid at room temperature and contains isocyanate groups,
b) at least one polyaldimine ALD of the formula (I a) or (I b), 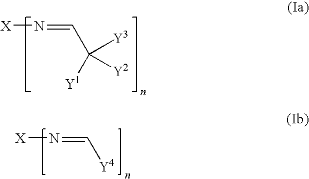
c) at least one acid K in the form of an organic monocarboxylic acid or dicarboxylic acid or of an organic monosulfonic acid or disulfonic acid, or of a compound which can be hydrolyzed to one of these acids;
wherein formula (I a) or (I b)
X is the organic radical of an n-functional primary polyamine following removal of n aliphatic primary amino groups,
this organic radical containing no moieties which in the absence of water are reactive with isocyanate groups, no secondary amino groups, no urea groups, and no other groups with active hydrogen;
n is 2 or 3 or 4;
Y¹ and Y²
either independently of one another are each a monovalent hydrocarbon radical having 1 to 12 C atoms,
or together are a divalent hydrocarbon radical having 4 to 20 C atoms which is part of an optionally substituted carbocyclic ring having 5 to 8 C atoms;
Y³ is a monovalent hydrocarbon radical which optionally contains at least one heteroatom in the form of ether, carbonyl or ester groups;
Y⁴ alternatively
is a substituted or unsubstituted aryl or heteroaryl group which has a ring size of between 5 and 8 atoms
or is 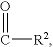
where R² is a hydrogen atom or is an alkoxy group,
or is a substituted or unsubstituted alkenyl or arylalkenyl group having at least 6 C atoms.

2. The moisture-reactive hotmelt adhesive composition of claim 1, wherein the solid polyurethane polymer P containing isocyanate groups is prepared from at least one polyol and at least one polyisocyanate.

3. The moisture-reactive hotmelt adhesive composition of claim 2, wherein the polyol is a polyester polyol, which is crystalline, partly crystalline, amorphous or liquid at room temperature, the polyester diol which is liquid at room temperature being solid at a temperature between 0° C. and 25° C. and being used in combination with at least one amorphous, partly crystalline or crystalline polyester polyol.

4. The moisture-reactive hotmelt adhesive composition of claim 2, wherein the polyol is a polycarbonate polyol.

5. The moisture-reactive hotmelt adhesive composition of claim 2, wherein the polyol is amorphous.

6. The moisture-reactive hotmelt adhesive composition of claim 1, wherein the polyurethane polymer P which is solid at room temperature is prepared using at least one diisocyanate.

7. The moisture-reactive hotmelt adhesive composition according to claim 1, wherein the polyurethane polymer P which is solid at room temperature is present in an amount of 40%-100% weight based on the overall hotmelt adhesive composition.

8. The moisture-reactive hotmelt adhesive composition of claim 1, wherein the n-functional primary polyamine is selected from the group consisting of 1,6-hexamethylenediamine, MPMD, DAMP, IPDA, 4-aminomethyl-1,8-octanediamine, 1,3-xylylenediamine, 1,3-bis(aminomethyl)cyclohexane, bis(4-aminocyclohexyl)methane, bis(4-amino-3-methylcyclohexyl)methane, 3(4),8(9)-bis(aminomethyl)tricyclo[5.2.1.0^{2,6}]decane, 1,4-diamino-2,2,6-trimethylcyclohexane, and polyoxyalkylene-polyamines having two or three amino groups, and also their mixtures with one another.

9. The moisture-reactive hotmelt adhesive composition of claim 1, wherein the polyaldimine ALD of the formula (I a) or (I b) is present in the hotmelt adhesive composition in an amount such that the ratio between aldimine groups and isocyanate groups is 0.1 to 1.1 equivalent of aldimine groups per equivalent of isocyanate groups.

10. The moisture-reactive hotmelt adhesive composition of claim 1, wherein Y¹ and Y² are each a methyl group.

11. The moisture-reactive hotmelt adhesive composition of claim 1, wherein Y³ is a radical of the formula (II) or (III) 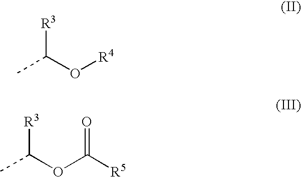
where R³ is a hydrogen atom or is an alkyl or arylalkyl group;
R⁴ is a hydrocarbon radical having 1 to 30 C atoms, which optionally contains heteroatoms; and
R⁵ alternatively
is a hydrogen atom,
or is a linear or branched alkyl radical having 1 to 30 C atoms, optionally with cyclic fractions and optionally with at least one heteroatom, or is a singly or multiply unsaturated, linear or branched hydrocarbon radical having 5 to 30 C atoms,
or is an optionally substituted aromatic or heteroaromatic, 5- or 6-membered ring.

12. The moisture-reactive hotmelt adhesive composition of claim 1, wherein the polyaldimine ALD has the formula (I a).

13. The moisture-reactive hotmelt adhesive composition of claim 1, wherein the acid K is an aromatic monocarboxylic acid.

14. The moisture-reactive hotmelt adhesive composition of claim 1, wherein the acid K is present in an amount of 0.001% to 5% by weight based on the overall hotmelt adhesive composition.

15. The moisture-reactive hotmelt adhesive composition of claim 1, wherein the hotmelt adhesive composition is free of fillers.

16. The moisture-reactive hotmelt adhesive composition of claim 1, wherein the polyurethane polymer P is amorphous.

17. A method of adhesively bonding a substrate S1 and a substrate S2, comprising the steps of
i) heating the moisture-reactive hotmelt adhesive composition of claim 1 to a temperature between 80° C. and 200° C.;
ii) applying the heated composition to a substrate S1;
iii) contacting the applied composition with a substrate S2;
the substrate S2 being composed of the same or a different material to the substrate S1.

18. The method of adhesive bonding of claim 17, wherein step iii) is followed by a step (iv) of chemically crosslinking the composition with moisture.

19. The method of adhesive bonding of claim 17, wherein the substrate S1 and/or S2 is a plastic, an organic material such as leather, fabric, paper, wood, a resin-bound woodbase material, a resin-textile composite material, glass, porcelain, ceramic or a metal or a metal alloy.

20. The method of adhesive bonding of claim 17, wherein the substrate S1 and/or S2 is a transparent material.

21. The method of adhesive bonding of claim 17, wherein the thickness of the adhesive in the bond is ≧10 micrometers.

22. An article adhesively bonded by a method of adhesive bonding of claim 17.

23. The article of claim 22, wherein the article is an article of the transport, furniture, textile or packaging sector.

24. A method of reducing bubble formation and of accelerating the chemical crosslinking of amorphous hotmelt adhesive compositions by admixing at least one amorphous polyurethane polymer P
as described in a moisture-reactive hotmelt adhesive composition of claim 1,
at least one polyaldimine ALD of the formula (I a) or (I b)
as described in a moisture-reactive hotmelt adhesive composition of claim 1,
and at least one acid K in the form of an organic monocarboxylic acid or dicarboxylic acid or of an organic monosulfonic acid or disulfonic acid or of a compound which can be hydrolyzed to one of these acids,
as described in a moisture-reactive hotmelt adhesive composition of claim 1.
